(19) United States
(12) Patent Application Publication
(10) Pub. No.: US 2013/0175256 A1
(43) Pub. Date: Jul. 11, 2013

(54) Heating Element Arrangement for a Vacuum Heat Treating Furnace

(71) Applicant: IPSEN, INC., Cherry Valley, IL (US)

(72) Inventors: Craig A. Moller, Roscoe, IL (US); Geoffrey Somary, Arlington Heights, IL (US)

(73) Assignee: IPSEN, INC., Cherry Valley, IL (US)

(21) Appl. No.: 13/728,128

(22) Filed: Dec. 27, 2012

Related U.S. Application Data
(60) Provisional application No. 61/581,335, filed on Dec. 29, 2011.

(51) Int. Cl. H05B 1/00

(52) U.S. Cl. CPC H05B 1/00
USPC 219/552

(57) ABSTRACT

A heating element arrangement for a vacuum heat treating furnace is disclosed. The heating element arrangement includes a central heating element array as well as first and second outboard heating element arrays spaced apart from and coaxially aligned with the central heating element array. The heating element arrangement also includes first and second end heating elements disposed at respective first and second end positions relative to the central heating element array and the first and second outboard heating element arrays. Power transformers are operatively connected to the central heating element array, to the first outboard heating element array and first end heating element array, and to the second outboard heating element array and second end heating element array for providing electric current to the respective heating element arrays.

### CROSS REFERENCE TO RELATED APPLICATION

This application claims the benefit of U.S. Provisional Application No. 61/581,335, filed Dec. 29, 2011, the entirety of which is incorporated herein by reference.

### BACKGROUND OF THE INVENTION

1. Field of the Invention

This invention relates generally to vacuum furnaces for the heat treatment of metal parts and in particular to a heating element arrangement for use in such a vacuum furnace.

2. Description of the Related Art

Many industrial vacuum furnaces for the heat treatment of metal work pieces utilize electrical resistance heating elements. The heating elements are made from different materials depending on the design requirements for the vacuum furnace. Usual heating element materials for high temperature furnaces include graphite and refractory metals such as molybdenum and tantalum. Heating elements for low and intermediate temperatures include stainless steel alloys, nickel-chrome alloys, nickel base superalloys, and silicon carbide. The heating elements are usually arranged in arrays around the interior of the hot zone so that the arrays surround a work load of metal pieces to be heat treated. In this manner, heat can be applied toward all sides of the work load. A known arrangement is shown schematically in FIG. 1. The heating elements in each array typically have the same electrical resistance and surface area. Therefore, each heating element generates the same amount of heat as every other heating element when energized.

The heating element arrays are connected in groups to provide multiple, separately energized, heating zones within the furnace hot zone as shown in FIG. 1. Each heating zone includes two or more heating element arrays connected to a single power source, such as an electrical transformer. The transformers are individually controlled to provide more or less electrical current to different heating zones. In this way, the heating zones are trimmable so that more or less heat can be applied to different sections of the work load or in different regions of the furnace hot zone.

When it is desired to provide heat near the ends of the work load for a greater degree of heating uniformity, end heating zones are used at front and rear ends of the hot zone for a horizontal furnace configuration or at top and bottom ends for a vertical furnace configuration. In the known vacuum furnaces, the end heating zones each have their own transformer connected thereto for supplying the energizing electric current. Typically, this requires two additional transformers, i.e, one for each of the end heating zone arrays. It would be desirable to reduce the complexity and cost of providing separate transformers for the end heating arrays while still providing the benefit of the additional heat applied to the ends of the work load during a heat treatment cycle for better heating uniformity.

### SUMMARY OF THE INVENTION

In accordance with a first aspect of the present invention there is provided a heating element arrangement for heating a work load in a vacuum heat treating furnace when the heating element arrangement is energized. The heating element arrangement includes a central heating element array that is constructed and arranged to fit substantially around the inner side of a vacuum furnace hot zone wall. The heating element arrangement also includes a first outboard heating element array spaced apart from the central heating element array and also constructed and arranged to fit substantially around the inner side of the vacuum furnace hot zone wall. The heating element arrangement of this invention also has a second outboard heating element array spaced from said central heating element array and constructed and arranged to fit substantially around the inner side of the hot zone wall, said second outboard heating element array being positioned on an opposite side of said central heating element array from said first outboard heating element. The central heating element array, the first outboard heating element array, and the second outboard heating element array are substantially coaxial with each other.

A first end heating element is located adjacent to the first outboard heating element array and oriented in a plane that is substantially perpendicular to the common axis of the central and outboard heating element arrays. A second end heating element is disposed adjacent to the second outboard heating element array and oriented in a plane that is substantially perpendicular to the common axis of the central and outboard heating element arrays.

A first power transformer is operatively connected to the central heating element array for providing electric current to the central heating element array. A second power transformer is operatively connected to the first outboard heating element array and the first end heating element for providing electric current to the first outboard heating element array and the first end heating element. A third transformer is operatively connected to the second outboard heating element array and the second end heating element for providing electric current to the second outboard heating element array and the second end heating element.

In accordance with another aspect of the present invention there is provided a method of connecting heating element arrays in a vacuum furnace comprising the following steps. A first power transformer is connected to a central heating element array in the vacuum furnace. A second power transformer is connected to a first end heating element array wherein the first end heating element array includes a first outboard heating element spaced from and coaxial with the central heating element array and a first end heating element positioned adjacent to the first outboard heating element and oriented in a plane that is substantially perpendicular to the common axis of the first outboard heating element and the central heating element array. A third power transformer is connected to a second end heating element array wherein the second end heating element array includes a second outboard heating element spaced from and coaxial with the central heating element array and a second end heating element positioned adjacent to the second outboard heating element and oriented in a plane that is substantially perpendicular to the common axis of said first outboard heating element and the central heating element array.

### BRIEF DESCRIPTION OF THE DRAWINGS

The foregoing summary as well as the following detailed description will be better understood when read in conjunction with the drawings, wherein:

FIG. 1 is a schematic diagram of a known multi-heating zone arrangement for a vacuum furnace;

FIG. 2 is a schematic diagram of multi-heating zone arrangement in accordance with the present invention;

FIG. 3 is a perspective view of a heating element arrangement in accordance with the present invention; and

FIG. 4 is an end elevation view of a vacuum furnace in which the heating element arrangement of FIG. 3 can be used.

### DETAILED DESCRIPTION

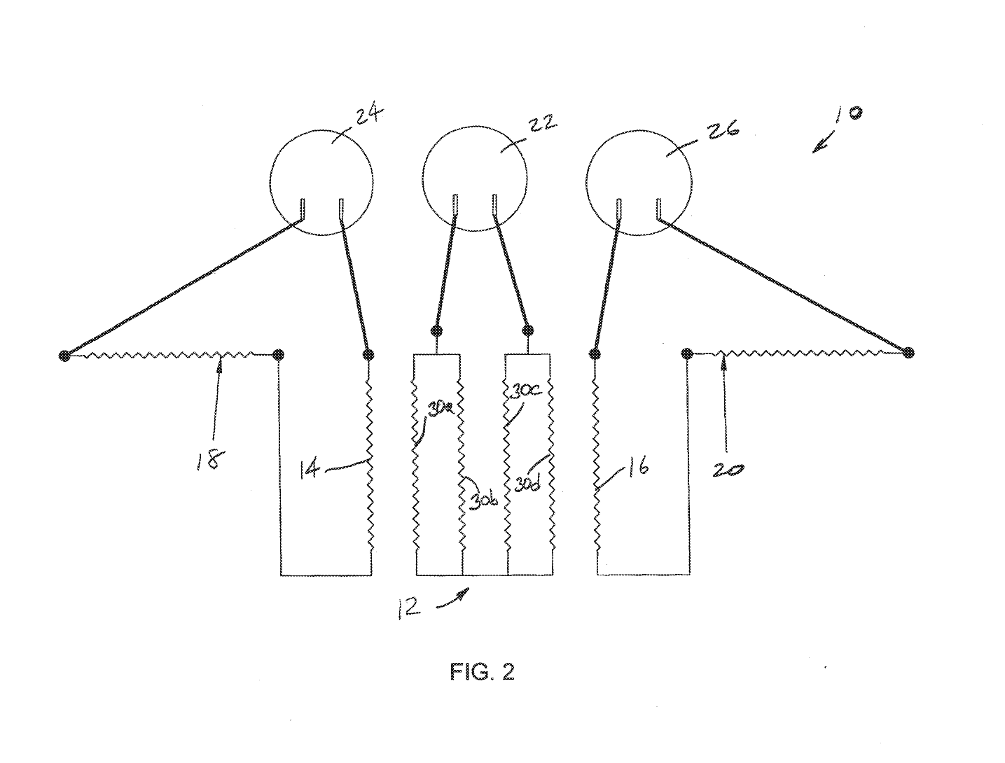

Referring now to the drawings wherein like reference numerals refer to the same or similar features across the views, and in particular to FIG. 2, there is shown schematically a heating element arrangement for a vacuum furnace in accordance with the present invention. The heating element arrangement 10 includes a central heating element array 12, a first outboard heating element array 14, a second outboard heating element array 16, a first end heating element 18, and a second end heating element 20. The central heating element array 12 is a circuit formed from two or more heating element sub-arrays 30. Central heating element array 12 is connected to a first power transformer 22 which supplies electric current to the central heating element array 12 when energized.

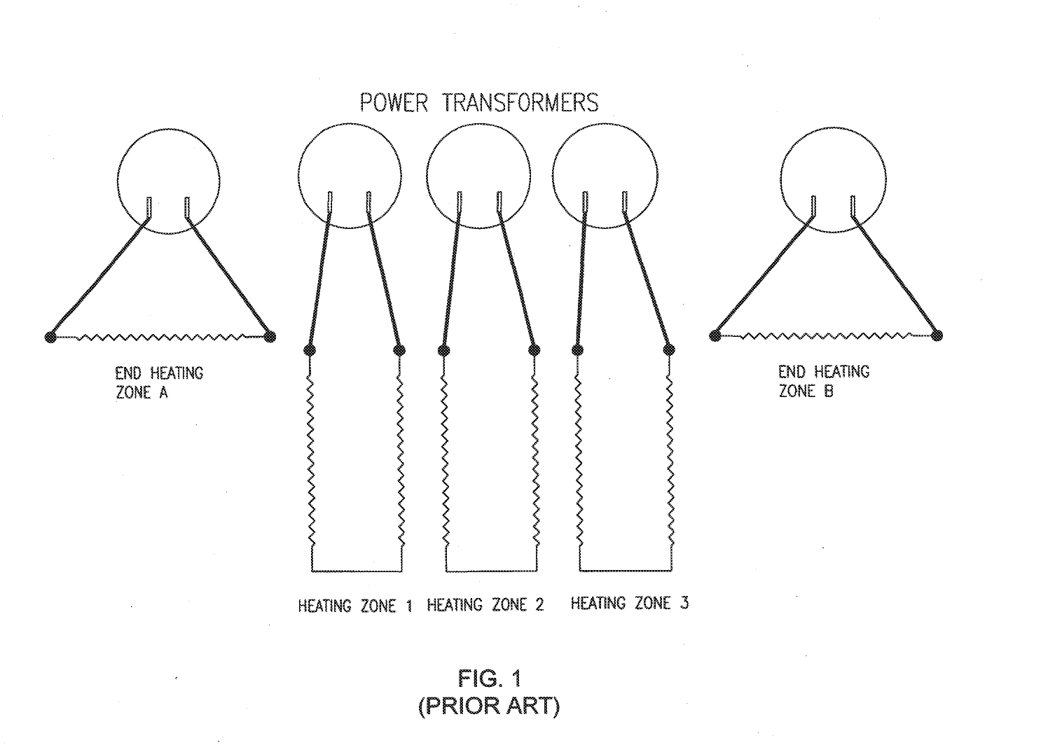

The first outboard heating element array 14 and the first end heating element 18 are electrically connected together to form a single electrical circuit. The electrical circuit is connected to a second power transformer 24 which, when energized, supplies electric current to the circuit formed by the first outboard heating element array 14 and the first end heating element 18. The second outboard heating element array 16 is electrically connected to the second end heating element 20 to form another electrical circuit. The electrical circuit formed by the second outboard heating element array 16 and the second end heating element 20 is connected to a third power transformer 26 which supplies electric current to the circuit when energized. However, it will be appreciated that second end heating element 20 is mounted on the inside of the pressure/vacuum vessel door and thus, is adapted to move with the door when it is opened and closed. Accordingly, the electrical connection(s) between the second end heating element 20 and the power transformer are made externally. In this regard, power cables or other flexible connectors are connected to the terminal ends 21a and 21b of the second end heating element 20. The connectors extend through the pressure/vacuum vessel door for connection to the second outboard heating element array 16 and the power transformer 26. It is readily apparent that the heating element arrangement shown in FIG. 2 provides the same quantity of heating elements as the known arrangement shown in FIG. 1. However, the arrangement in accordance with the present invention has fewer power transformers.

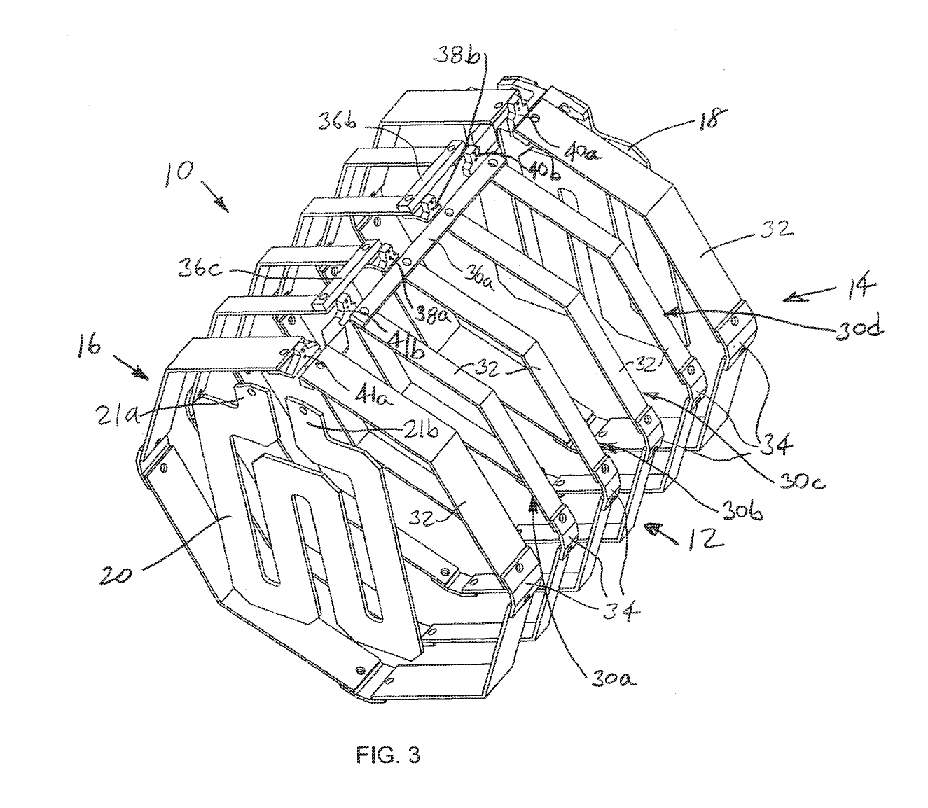

Referring now to FIG. 3 of the drawings, there is shown an embodiment of a heating element arrangement in accordance with the present invention. The heating element arrangement 10 includes the central heating element array 12, the first outboard heating element array 14, the second outboard heating element 16, the first end heating element 18, and second end heating element 20. The central heating element array 12 is formed from four heating element sub-arrays 30a, 30b, 30c, and 30d in the embodiment shown. However, the central heating element array may include more or fewer sub-arrays. Moreover, additional central heating element arrays may be included depending on the size of the vacuum furnace. The additional central heating element arrays would each be connected to their own transformer. However, it will be appreciated, the total number of transformers required will always be fewer than with the known connection schemes.

The first and second outboard heating element arrays 14, 16 and the heating element sub-arrays 30a, 30b, 30c, and 30d are constructed in the known manner from pluralities of heating element segments 32 that are connected together. The heating element segments 32 are connected together with segment connectors 34 in a known manner. The heating element sub-arrays 30a, 30b, 30c, and 30d are connected together by means of the sub-array connectors 36a, 36b, and 36c to form the central heating element array 12 as shown. Terminal connector 38a is attached at one end of heating element array 12 and terminal connector 38b is attached to the other end of heating element array 12. The terminal connectors 38a and 38b provide connection points so that the central heating element array 12 can be connected to a power transformer (not shown).

A terminal connector 40a is attached to one end of first outboard heating element array 14 and terminal connector 40b is attached to an end of the first end heating element 18 so that the circuit formed by outboard heating element array 14 and first end heating element 18 can be connected to a power transformer (Not shown). Terminal connectors 41a and 41b are attached to opposite ends of first outboard heating element array 16 so that one end of the outboard heating element array 16 can be connected to a power transformer (Not shown) and the other end can be connected to one terminal end of the second end heat heating element 20. The other terminal end of second end heating element 20 is connected externally to the power transformer as described above in reference to FIG. 2.

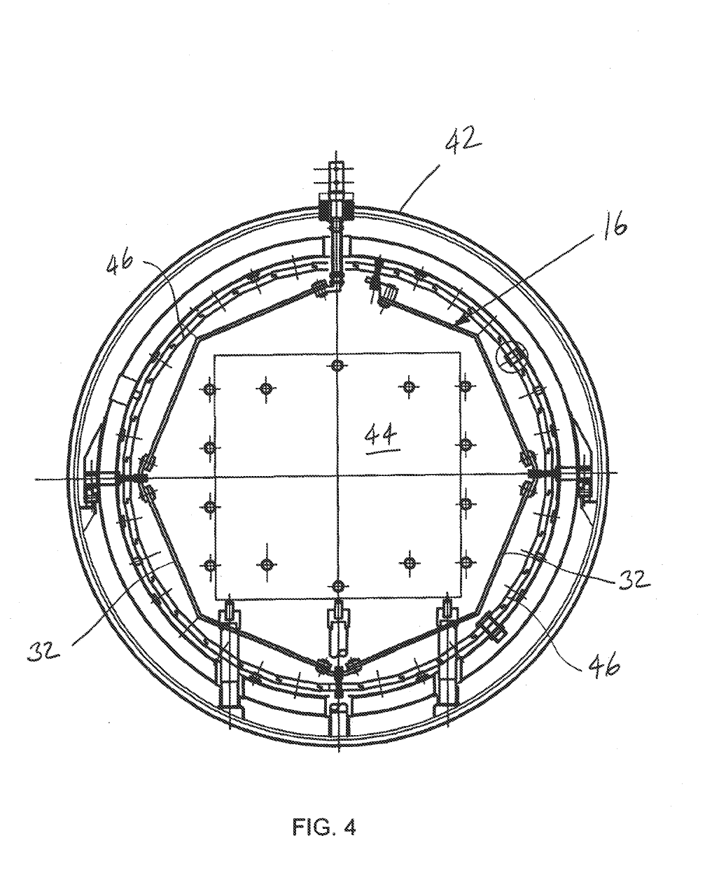

The heating element segments 32, segment connectors 34, sub-array connectors 36a-36c, and the terminal connectors 38, 40a, and 40b can be formed from any of the known materials used for electrical heating elements in vacuum furnaces. Preferably, the heating element segments and connectors are formed from graphite or from a refractory metal such as molybdenum, tungsten, or tantalum. The heating element shapes can be flat, round, and/or curved and can have any suitable cross-sectional geometry. The heating element segments and arrays can be shaped for use in either round or rectangular hot zones so that the heating element arrays substantially conform to the inside shape of the hot zone. For example, the heating element arrangement shown in FIG. 3 is designed for use in a circular hot zone. Shown in FIG. 4 is a typical arrangement for a vacuum heat treating furnace. The vacuum furnace includes a pressure/vacuum vessel 42. Inside the pressure/vacuum vessel is a hot zone 44 that is defined by a hot zone wall 46. In the vacuum furnace shown in FIG. 4, the hot zone has a substantially circular cross section. The heating element sub-arrays 30a, 30b, 30c, and 30d have their heating element segments shaped so that the heating element sub-arrays substantially conform to the circular shape of the hot zone wall. As an alternative, the heating element segments could be curved or arcuate in shape to better conform to the hot zone wall and provide more interior space in the hot zone. Such an arrangement is shown in U.S. Pat. No. 5,965,050, the entirety of which is incorporated herein by reference. It will be appreciated by those skilled in the art that the heating element arrays and sub-arrays can be connected as series or parallel circuits or as a combination of a serial circuit and a parallel circuit.

In view of the foregoing description of a heating element arrangement in accordance with the present invention, some of the benefits and advantages of the arrangement will now be better understood. For example, the new heating element arrangement connects the end elements in combination with adjacent outboard elements to form one heating zone. This provides for more element coverage, i.e., more surface area, but utilizes a single power transformer. The heating element arrangement in accordance with the present invention reduces the complexity and cost of making a vacuum heat treating furnace relative to the known arrangements because the invention reduces the number of power transformers required to energize the heating element arrays. Further, additional element coverage in the arrangement according to the invention will provide for more uniform heating of the work pieces in the vacuum furnace utilizing the same power source. Element cross sections and surface areas are specifically designed to adjust the heat load (watt density) on the surface of the heating elements in order to provide for the best heating uniformity. In this regard, the width, thickness, cross-sectional geometries, or the surface areas of the heating element segments can be varied as described in copending nonprovisional application entitled “Compensating Heating Element Arrangement For A Vacuum Heat Treating Furnace”, Application No. ______, filed Dec. 2______, 2012, the entirety of which is incorporated herein by reference.

The terms and expressions which have been employed are used as terms of description and not of limitation. There is no intention in the use of such terms and expressions of excluding any equivalents of the features or steps shown and described or portions thereof. It is recognized, therefore, that various modifications are possible within the scope and spirit of the invention. Accordingly, the invention incorporates variations that fall within the scope of the invention as described.

1. A heating element arrangement for heating a work load in a vacuum heat treating furnace when said heating element arrangement is energized, wherein said heating element arrangement comprises:
a central heating element array constructed and arranged to fit substantially around the inner side of a hot zone wall;
a first outboard heating element array spaced apart from said central heating element array and constructed and arranged to fit substantially around the inner side of the hot zone wall;
a second outboard heating element array spaced from said central heating element array and constructed and arranged to fit substantially around the inner side of the hot zone wall, said second outboard heating element array being positioned on an opposite side of said central heating element array from said first outboard heating element;
said central heating element array, said first outboard heating element array, and said second outboard heating element array being substantially coaxial;
a first end heating element disposed at a first end position in a plane that is substantially perpendicular to a longitudinal axis of a hot zone defined by the hot zone wall;
a second end heating element disposed at a second end position opposite said first end position and in a plane that is substantially perpendicular to the longitudinal axis of the hot zone;
a first transformer operatively connected to the central heating element array for providing electric current to said central heating element array;
a second transformer operatively connected to said first outboard heating element array and said first end heating element array for providing electric current to said first outboard heating element array and said first end heating element array; and
a third transformer operatively connected to said second outboard heating element array and said second end heating element array for providing electric current to said second outboard heating element array and said second end heating element array.

2. The heating element arrangement set forth in claim 1 wherein the central heating element array comprises two heating element subarrays and a connector for interconnecting the two heating element subarrays together.

3. The heating element arrangement set forth in claim 2 wherein each heating element subarray comprises a plurality of heating element segments and a plurality of segment connectors for interconnecting pairs of the heating element segments together.

4. The heating element arrangement set forth in claim 1 wherein the central heating element array comprises a plurality of heating element subarrays and a plurality of connectors arranged for interconnecting the plurality of heating element subarrays together to form said central heating element array.

5. The heating element arrangement set forth in claim 4 wherein each heating element subarray comprises a plurality of heating element segments and a plurality of segment connectors for interconnecting pairs of the heating element segments together.

6. A vacuum heat treating furnace comprising:
a pressure/vacuum vessel having a wall that defines a chamber;
a hot zone wall mounted to the vessel wall in the chamber, said hot zone wall defining a hot zone inside the chamber; and
a heating element arrangement as set forth in claim 1 arranged inside said hot zone.

7. The vacuum furnace set forth in claim 6 wherein the central heating element array comprises two heating element subarrays and a connector for interconnecting the two heating element subarrays together.

8. The heating element arrangement set forth in claim 7 wherein each heating element subarray comprises a plurality of heating element segments and a plurality of segment connectors for interconnecting pairs of the heating element segments together.

9. The heating element arrangement set forth in claim 6 wherein the central heating element array comprises a plurality of heating element subarrays and a plurality of connectors arranged for interconnecting the plurality of heating element subarrays together to form said central heating element array.

10. The heating element arrangement set forth in claim 9 wherein each heating element subarray comprises a plurality of heating element segments and a plurality of segment connectors for interconnecting pairs of the heating element segments together.

11. A method of connecting heating element arrays in a vacuum furnace comprising the steps of:
connecting a first power transformer to a central heating element array;
connecting a second power transformer to a first end heating element array wherein said first end heating element array comprises:
a first outboard heating element spaced from and coaxial with said central heating element array; and
a first end heating element positioned adjacent to the first outboard heating element and oriented in a plane that is substantially perpendicular to a common axis of the first outboard heating element and the central heating element array; and
connecting a third power transformer to a second end heating element array wherein said second end heating element array comprises:
a second outboard heating element spaced from and coaxial with said central heating element array; and
a second end heating element positioned adjacent to the second outboard heating element and oriented in a plane that is substantially perpendicular to a common axis of said first outboard heating element and the central heating element array.
